(19) United States
(12) Patent Application Publication
(10) Pub. No.: US 2026/0241977 A1
(43) Pub. Date: Aug. 20, 2026

(54) FOLDABLE STEERING WHEEL

(71) Applicant: KOMOS CO., LTD., Hwaseong-si Gyeonggi-do (KR)

(72) Inventors: Hyeon Muk KIM, Seoul (KR); Dong Min KIM, Anyang-si Gyeonggi-do (KR); In Chul YOO, Hwaseong-si Gyeonggi-do (KR)

(73) Assignee: KOMOS CO., LTD., Hwaseong-si Gyeonggi-do (KR)

(21) Appl. No.: 19/421,328

(22) Filed: Dec. 16, 2025

(30) Foreign Application Priority Data
Feb. 14, 2025 (KR) 10-2025-0019551

(51) Int. Cl. B62D 1/06; B62D 1/10

(52) U.S. Cl. CPC B62D 1/06; B62D 1/10

(57) ABSTRACT

Provided is a foldable steering wheel. The foldable steering wheel includes a hub, a rim moving relative to the hub, and an actuator unit moving the rim with respect to the hub, the actuator unit includes a motor, and a cycloid gear reducer receiving power from an output shaft of the motor, and an output shaft of the cycloid gear reducer is connected to one end of the rim to move the rim between a first position in an unfolded state for a driver to grip the rim and a second position in a folded state.

### CROSS-REFERENCE TO RELATED APPLICATION

This application claims priority to Korean Patent Application No. 10-2025-0019551 filed on February 14, 2025, the entire contents of which are herein incorporated by reference.

### BACKGROUND

### 1. Field

The disclosure relates to a foldable steering wheel. More particularly, the disclosure relates to a foldable steering wheel capable of securing driver's seat space by folding the steering wheel.

### 2. Description of the Related Art

General steering wheels have rims with large diameters disposed in driver's seat space for drivers' operation convenience. Drivers' postures in driver's seats are limited due to the sizes and positions of rims. Therefore, there is a problem that drivers are unable to take sufficient rest in relaxed postures in the driver's seats.

In addition, due to the fixed shapes and fixed positions of the rims, drivers' actions in the driver's seats are restricted, which causes a problem of narrowing the range of drivers' movements when driving autonomous vehicles.

### SUMMARY

Provided is a foldable steering wheel with a rim that folds or unfolds.

Provided is a foldable steering wheel capable of increasing torque for rotating a rim and simultaneously reducing noise while saving space by using a cycloid gear reducer.

Provided is a foldable steering wheel with a self-locking function to prevent a driver from forcibly rotating a rim.

The solutions of the disclosure are not limited to the above-mentioned contents, and other technical problems not mentioned will be clearly understood by one of ordinary skill in the art from the following description.

According to an embodiment of the disclosure, a foldable steering wheel includes a hub, a rim moving relative to the hub, and an actuator unit moving the rim with respect to the hub, the actuator unit includes a motor, and a cycloid gear reducer receiving power from an output shaft of the motor, and an output shaft of the cycloid gear reducer is connected to one end of the rim to move the rim between a first position in an unfolded state for a driver to grip the rim and a second position in a folded state.

The actuator unit may further include a bevel gear reducer provided between the output shaft of the motor and the cycloid gear reducer and using a bevel gear.

The cycloid gear reducer may include an input shaft to which rotational power of the motor is input, a sun gear unit having a hollow into which the input shaft is inserted and eccentrically rotating in conjunction with the rotation of the input shaft, an input ring gear engaged with a first sun gear of the sun gear unit in a cycloid motion manner, and an output ring gear engaged with a second sun gear of the sun gear unit in the cycloid motion manner and rotating.

The input shaft may include an eccentric cam portion inserted into the hollow of the sun gear unit, and the sun gear unit may eccentrically rotate according to the rotation of the input shaft.

The second sun gear of the sun gear unit may include a plurality of sun gears having a phase difference with different tooth shapes and disposed side by side.

The second sun gear may include two sun gears having a phase difference of 180 degrees and disposed side by side, and the eccentric cam portion of the input shaft may include two cam portions having a phase difference of 180 degrees.

The bevel gear reducer may include a first bevel gear portion intersecting the output shaft of the motor, and a second bevel gear portion intersecting a rotation shaft of the first bevel gear portion, and the input shaft of the cycloid gear reducer may be coaxially connected to a rotation shaft of the second bevel gear portion.

According to an embodiment of the disclosure, a foldable steering wheel includes a hub, an upper rim and a lower rim moving relative to the hub, and an actuator unit moving the upper rim and the lower rim with respect to the hub, the actuator unit includes a motor, and a pair of cycloid gear reducers receiving power from an output shaft of the motor, and output shafts of the pair of cycloid gear reducers are connected to one end of the upper rim and one end of the lower rim, respectively, to move the upper rim and the lower rim between a first position in an unfolded state for a driver to grip the upper rim and the lower rim and a second position in a folded state.

Interlocking gears engaged with each other and rotating may be provided at one end of the upper rim and one end of the lower rim, respectively, and the motion of any one of the upper rim and the lower rim may be linked to the motion of another rim.

### BRIEF DESCRIPTION OF THE DRAWINGS

FIGS. 1A and 1B are perspective views respectively illustrating an unfolded state and a folded state of a foldable steering wheel according to an embodiment of the disclosure;

FIG. 2 is an exploded perspective view of the foldable steering wheel of FIGS. 1A and 1B;

FIG. 3 is a diagram illustrating main portions of the foldable steering wheel of FIGS. 1A and 1B;

FIG. 4 is an exploded perspective view of an actuator unit of a foldable steering wheel according to an embodiment of the disclosure;

FIG. 5 is an exploded perspective view of the main configuration of a bevel gear reducer of a foldable steering wheel according to an embodiment of the disclosure;

FIG. 6 is an exploded perspective view of the main configuration of a cycloid gear reducer of a foldable steering wheel according to an embodiment of the disclosure;

FIG. 7 is an exploded perspective view of the main configuration of a cycloid gear reducer of a foldable steering wheel according to an embodiment of the disclosure;

FIGS. 8A to 8C are respectively a perspective view, a front view, and a cross-sectional view of a cycloid gear reducer of a foldable steering wheel according to an embodiment of the disclosure; and

FIG. 9 is a perspective view of sun gears used in a cycloid gear reducer of a foldable steering wheel according to an embodiment of the disclosure.

### DETAILED DESCRIPTION

The disclosure will now be described more fully with reference to the accompanying drawings, in which embodiments of the disclosure are shown. These embodiments are provided so that the disclosure will be thorough and complete, and will fully convey the concept of the disclosure to those of skill in the art. The disclosure may, however, be embodied in many different forms and should not be construed as being limited to the embodiments set forth herein. For clarity, portions that are not relevant to the description of the present disclosure are omitted.

The terms used in the present specification are merely used to describe particular embodiments of the disclosure, and are not intended to limit the disclosure. An expression used in the singular encompasses the expression of the plural, unless it has a clearly different meaning in the context.

In the present specification, it is to be understood that the terms such as "including", "having," and "comprising" are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added.

In addition, the components shown in the embodiments of the disclosure are shown independently to represent different characteristic functions, and do not mean that each component includes separate hardware or one software unit. That is, each component is described by listing each component for convenience of description, and at least two of the components may be combined to form one component, or one component may be divided into a plurality of components to perform a function. The integrated and separated embodiments of each of these components are also included within the scope of the disclosure without departing from the spirit of the disclosure.

In addition, embodiments below are provided so that the present disclosure will be thorough and complete, and will fully convey the concept of the disclosure to those skilled in the art. In the drawings, sizes and thicknesses of components may be exaggerated for clarity.

Hereinafter, the disclosure will be described in detail with reference to the attached drawings.

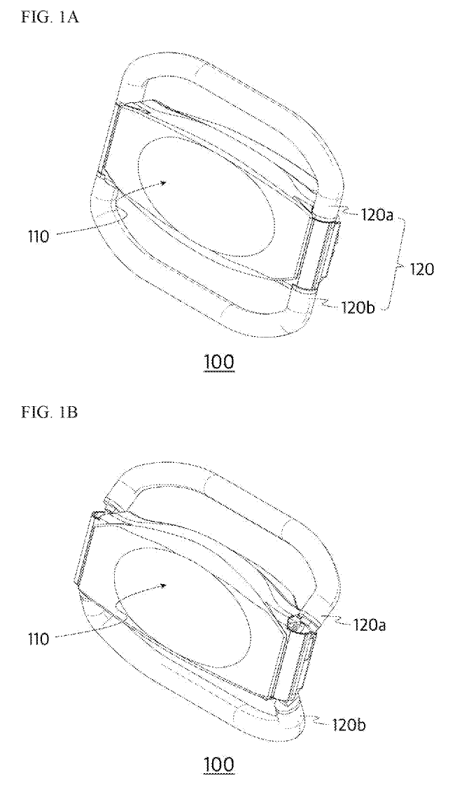

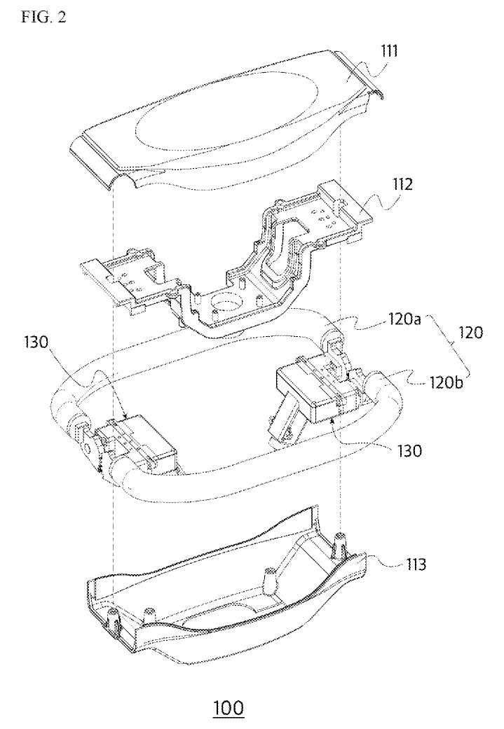

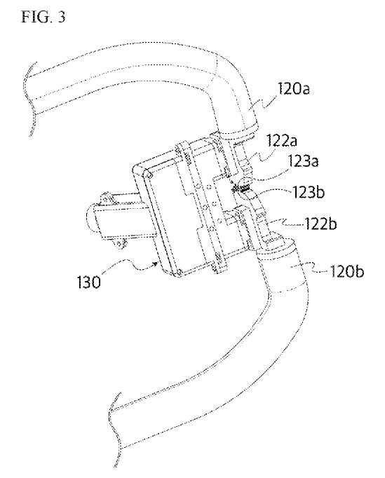

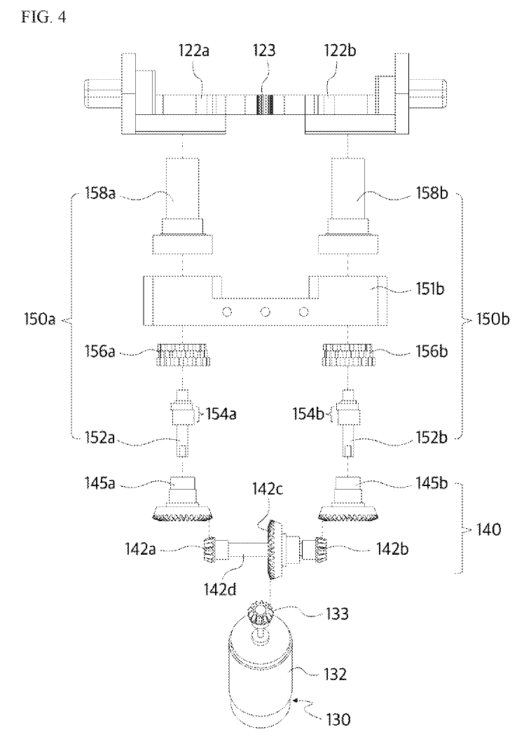

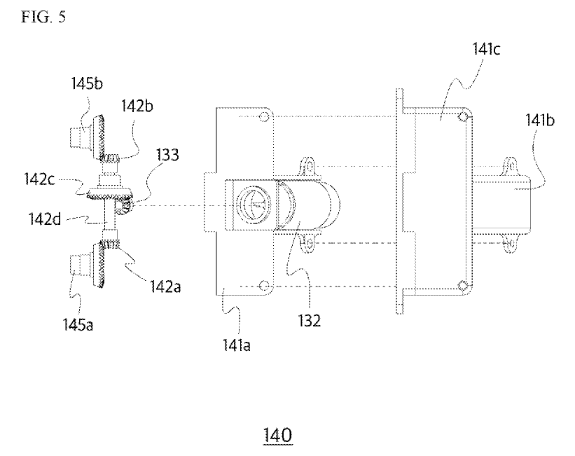

FIGS. 1A and 1B are perspective views respectively illustrating an unfolded state and a folded state of a foldable steering wheel 100 according to an embodiment of the disclosure. FIG. 2 is an exploded perspective view of the foldable steering wheel 100 of FIGS. 1A and 1B. FIG. 3 is a diagram illustrating main portions of the foldable steering wheel 100 of FIGS. 1A and 1B. FIG. 4 is an exploded perspective view of an actuator unit 130 of a foldable steering wheel 100 according to an embodiment of the disclosure. FIG. 5 is an exploded perspective view of the main configuration of a bevel gear reducer 140 of a foldable steering wheel 100 according to an embodiment of the disclosure.

Referring to FIGS. 1A to 5, the foldable steering wheel 100 according to an embodiment of the disclosure is capable of conversion between a folding position and an unfolding position, thereby improving the convenience of a driver and the utilization of vehicle space. The foldable steering wheel 100 may implement a foldable function by rotating an upper rim 120a and a lower rim 120b with respect to a hub 110, thereby increasing the utilization of driver's seat space. The foldable steering wheel 100 may include the hub 110, a rim 120; 120a, 120b, and the actuator unit 130. The hub 110 is a central part of the foldable steering wheel 100, and may be connected to a steering column of a vehicle, accommodate an airbag therein, and accommodate various components. The hub 110 may include an upper cover 111, a main frame 112, and a lower cover 113, and the actuator unit 130 may be mounted on the main frame 112.

The rim 120 is a part gripped by the driver, and in the present embodiment, the upper rim 120a and the lower rim 120b may be provided separately to move relative to the hub 110. In an embodiment, the upper rim 120a and the lower rim 120b may rotate in opposite directions. When the upper rim 120a rotates clockwise, the lower rim 120b may rotate counterclockwise in conjunction with the motion of the upper rim 120a. To the contrary, when the upper rim 120a rotates counterclockwise, the lower rim 120b may rotate clockwise in conjunction with the motion of the upper rim 120a.

The actuator unit 130 may move the rim 120 relative to the hub 110, and may rotate the upper rim 120a and the lower rim 120b between a first position in a state where the rim 120 unfolds for the driver to grip the rim 120 and a second position in a state where the rim 120 folds. A pair of actuator units 130 may be provided at both ends of the hub 110 or one actuator unit 130 may be provided at any one end of the hub 110. In the present embodiment, the actuator units 130 may be provided at both ends of the hub 110 to rotate both ends of the upper rim 120a and the lower rim 120b, respectively. When the actuator units 130 are provided at both ends of the hub 110, the torque for rotating the rim 120 is applied equally to both ends of the rim 120, thereby more stably rotating the rim 120.

The actuator unit 130 may include a motor 132 that generates a rotational force and a cycloid gear reducer 150; 150a, 150b. The cycloid gear reducer 150 may receive power from an output shaft of the motor 132, but may increase the rotational torque of the motor 132 while decelerating the rotational speed of the motor 132. In addition, an output shaft (output ring gear) 158; 158a, 158b of the cycloid gear reducer 150 may be connected to ends 122a and 122b of the upper rim 120a and the lower rim 120b to rotate the upper rim 120a and the lower rim 120b. In the present embodiment, the two cycloid gear reducers 150a and 150b may be disposed in one actuator unit 130, and may be disposed parallel to each other. One 150a of a pair of cycloid gear reducers 150a and 150b may be used to rotate the upper rim 120a, and the other 150b may be used to rotate the lower rim 120b. Accordingly, the same rotational torque may be transmitted to the upper rim 120a and the lower rim 120b.

On the other hand, the actuator unit 130 according to an embodiment of the disclosure may further include the bevel gear reducer 140 provided between the output shaft of the motor 132 and the cycloid gear reducer 150 and using a bevel gear to primarily reduce the rotational speed of the output shaft of the motor 132. The bevel gear reducer 140 may include a first bevel gear portion 142; 142a, 142b, 142c, 142d intersecting the output shaft of the motor 132, and a second bevel gear portion 145; 145a, 145b intersecting a rotation shaft (a first shaft) 142d of the first bevel gear portion 142. An input shaft 152; 152a, 152b of the cycloid gear reducer 150 may be coaxially connected to a rotation shaft of the second bevel gear portion 145. In the present embodiment, the first bevel gear portion 142 may include a first shaft 142d disposed to intersect the output shaft of the motor 132, and a first bevel gear 142c provided at a center part of the first shaft 142d to engage with a gear 133 provided at the output shaft of the motor 132. In addition, the first bevel gear portion 142; 142a, 142b may be provided at each end of the first shaft 142d. A pair of second bevel gear portions 145 may be provided to intersect the first shaft 142d of the first bevel gear portion 142 and be engaged with a pair of pinion gears 142a and 142b, respectively. Rotation shafts of the second bevel gears 145a and 145b may be coaxially connected to the input shafts 152a and 152b of a pair of cycloid gear reducers 150a and 150b, respectively. In an embodiment, the input shafts 152a and 152b of the cycloid gear reducers 150a and 150b may be rotation shafts of the second bevel gears 145a and 145b, respectively. The bevel gear reducer 140 is secondarily decelerated through the first bevel gear portion 142 and the second bevel gear portion 145, and thus, the output torque of the motor 132 may be amplified, and subsequently, the rotational speed of the motor 132 is further decelerated through the cycloid gear reducer 150, and thus, the output torque of the motor 132 may be further amplified. Meanwhile, because the gear 133 provided on the output shaft of the motor 132 and the first bevel gear 142c of the first bevel gear portion 142 are bevel gears, the bevel gear reducer 140, the cycloid gear reducer 150, and the motor 132 disposed on the same plane may be installed obliquely at a predetermined angle. Accordingly, the actuator unit 130 occupies a small space in the hub 110, and thus, space utilization in the hub 110 may be increased.

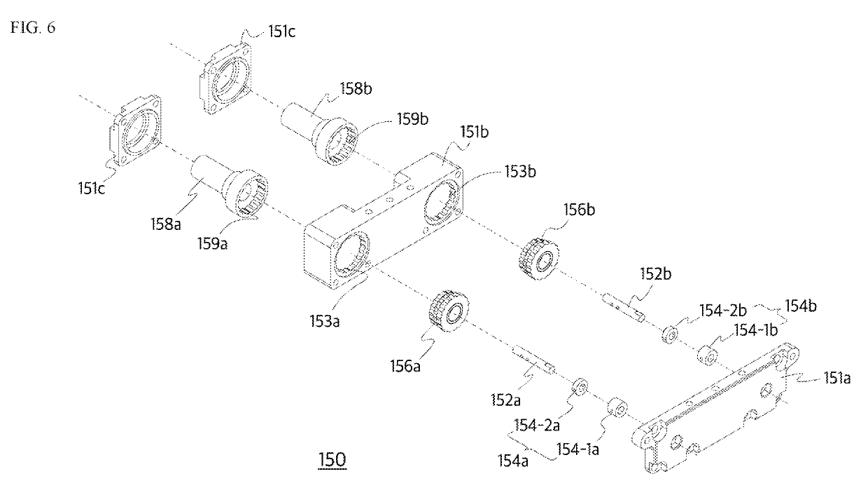

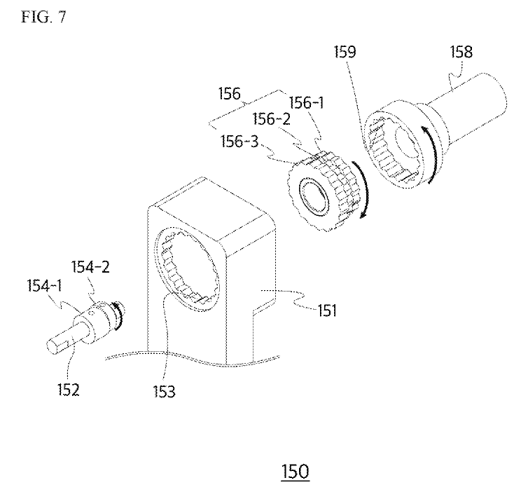

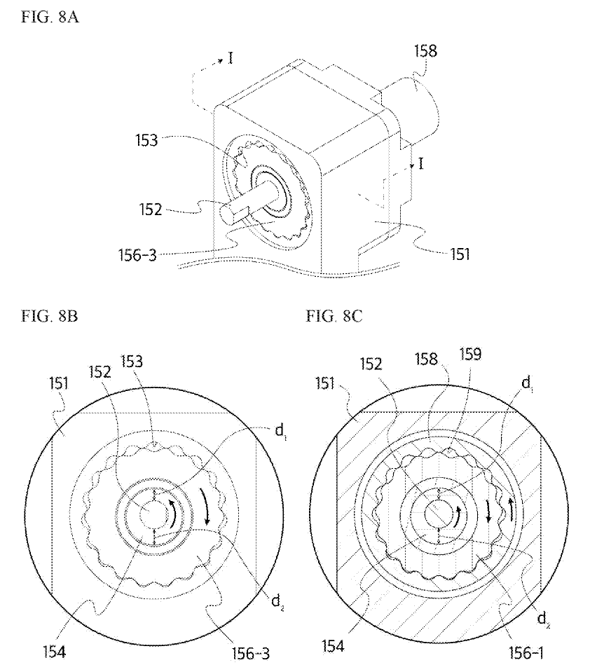

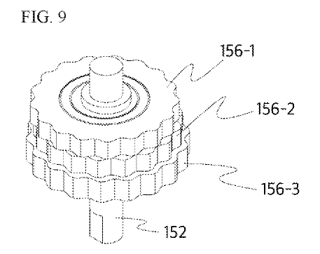

FIG. 6 is an exploded perspective view of the main configuration of the cycloid gear reducer 150 of the foldable steering wheel 100 according to an embodiment of the disclosure. FIG. 7 is an exploded perspective view of the main configuration of the cycloid gear reducer 150 of the foldable steering wheel 100 according to an embodiment of the disclosure. FIGS. 8A to 8C are respectively a perspective view, a front view, and a cross-sectional view of the cycloid gear reducer 150 of the foldable steering wheel 100 according to an embodiment of the disclosure. FIG. 9 is a perspective view of sun gears used in the cycloid gear reducer 150 of the foldable steering wheel 100 according to an embodiment of the disclosure.

Hereinafter, the configuration of the cycloid gear reducer 150 according to an embodiment of the disclosure will be described in more detail with reference to FIGS. 6 to 9.

The cycloid gear reducer 150 according to an embodiment of the disclosure may include the input shaft 152, a sun gear unit 156, an input ring gear 153, and an output ring gear 159. Rotational power of the motor 132 may be input to the input shaft 152. In the absence of the bevel gear reducer 140, the rotational power of the motor 132 may be directly transmitted, but in the present embodiment, the rotational power of the motor 132 in which the rotational torque of the motor 132 is decelerated while passing through the bevel gear reducer 140 and is primarily increased may be input to the input shaft 152. In the present embodiment, the two cycloid gear reducers 150a and 150b may be provided parallel to each other in one actuator unit 130, so that the one cycloid gear reducer 150a may be connected to one end 122a of the upper rim 120a, and the other cycloid gear reducer 150b may be connected to one end 122b of the lower rim 120b. The sun gear unit 156; 156a, 156b may have a hollow in the center into which the input shaft 152; 152a, 152b is inserted, and may rotate in conjunction with the rotation of the input shaft 152 but may be rotated eccentrically. As shown in FIGS. 7 and 8, when the input shaft 152 rotates counterclockwise, the cycloid motion of a contact surface between a first sun gear 156-3 of the sun gear unit 156 and the input ring gear 153 may be performed by an eccentric cam portion 154-1 provided on the input shaft 152. Accordingly, the sun gear unit 156 rotates clockwise. Similarly, the cycloid motion of a contact surface between second sun gears 156-2 and 156-3 of the sun gear unit 156 and the output ring gear 159 is performed by eccentric cam portions 154-1 and 154-2 provided on the input shaft 152, and the output ring gear 159 and the output shaft 158 rotate counterclockwise.

The sun gear unit 156 may include two types of sun gears, that is, the first sun gear 156-3 and the second sun gears 156-1 and 156-2, which may be provided coaxially parallel to each other. The input ring gear 153; 153a, 153b may be engaged with the first sun gear 156-3 of the sun gear unit 156 in a cycloid motion manner. In more detail, an inner circumferential surface of the input ring gear 153 and an outer circumferential surface of the first sun gear 156-3 which are provided in a fixed state in a housing 151b of the cycloid gear reducer 150 may be in contact with each other in the cycloid motion manner, and parts of the input ring gear 153 and the first sun gear 156-3 may be sequentially engaged with each other. In addition, the output ring gear 159 connected to one end of the rim 120 may be engaged with the second sun gears 156-1 and 156-2 of the sun gear unit 156 in the cycloid motion manner. In more detail, an inner circumferential surface of the output ring gear 159 and outer circumferential surfaces of the second sun gears 156-1 and 156-2 may be in contact with each other in the cycloid motion manner, and parts of the output ring gear 159 and the second sun gears 156-1 and 156-2 may be sequentially engaged with each other. Accordingly, the output ring gear 159 may be decelerated and rotated with the increased torque. In an embodiment, the output ring gear 159 may be rotated while being supported by a bearing (not shown) in the housing 151b. In an embodiment, the input ring gear 153 may be integrally molded into the housing 151b of the cycloid gear reducer 150. Covers 151a and 151c may be provided on both sides of the housing 151b.

FIG. 8A is a perspective view of the cycloid gear reducer 150 of the foldable steering wheel 100 according to an embodiment of the disclosure, FIG. 8B is a front view of FIGS. 8A, and FIG. 8C is a cross-sectional view taken along line I-I of FIG. 8A.

Referring to FIGS. 7 and 8A to 8C, the input shaft 152 may include the eccentric cam portion 154; 154-1, 154-2 inserted into the hollow of the sun gear unit 156. Accordingly, the sun gear unit 156 may also eccentrically rotate as the eccentric cam portion 154 rotates according to the rotation of the input shaft 152. As shown in FIGS. 8B and 8C, the eccentric cam portion 154 is eccentric with respect to the input shaft 152 so that a distance between the eccentric cam portion 154 and the outer circumferential surface of the input shaft 152 is a shortest distance d1 and a farthest distance d2. In addition, owing to the eccentricity of the eccentric cam portion 154, the rotational direction of the input shaft 152 and the rotational direction of the sun gear unit 156 may be opposite to each other.

The cycloid gear reducer 150 according to the present embodiment may implement a self-locking function. Referring to FIGS. 7 and 8A to 8C, according to the power transmission order of the cycloid gear reducer 150, because the input ring gear 153 has a structure fixed to the housing 151b (integrally formed with the housing 151b in the present embodiment), as the input shaft 152 rotates counterclockwise, the first sun gear 156-3 may rotate clockwise while performing cycloid motion on the inner circumferential surface of the input ring gear 153. In addition, the second sun gears 156-1 and 156-2 also rotate clockwise together with the first sun gear 156-3 and perform cycloid motion on the inner circumferential surface of the output ring gear 159. As the second sun gears 156-1 and 156-2 rotate clockwise, the output ring gear 159 of the output shaft 158 connected to the rim 120 receives rotational torque and rotates counterclockwise. That is, because the output ring gear 159 is a rotating body, the output ring gear 159 rotates in the same rotational direction as the input shaft 152. The rotational torque of the input shaft 152 may be transmitted to the output ring gear 159 in an increased state. On the other hand, the rotational torque of the input shaft 152 in the opposite direction may not be transmitted to the output ring gear 159. That is, even though a user attempts to forcibly rotate the rim 120, because the input ring gear 153 is fixed, the force for the user to rotate the rim 120 is transmitted to the input ring gear 153 through the sun gear unit 156, but the input ring gear 153 has a non-rotatable structure. Accordingly, because the second sun gears 156-1 and 156-2, and the first sun gear 156-3 of the sun gear unit 156 may not be rotated, the input shaft 152 may not be rotated.

Referring to FIG. 9, in an embodiment, a plurality of second sun gears 156-1 and 156-2 of the sun gear unit 156 may be provided side by side, and the plurality of second sun gears 156-1 and 156-2 having the same diameter but a phase difference with different tooth shapes may be disposed side by side. In the present embodiment, the two second sun gears 156-1 and 156-2 having a phase difference of 180 degrees may be coaxially disposed side by side, and the two cam portions 154-1 and 154-2 of the input shaft 152 may also be disposed side by side so as to have a phase difference of 180 degrees. The plurality of second sun gears 156-1 and 156-2 having a phase difference are provided, and thus, it is advantageous for continuous force transmission, and the output ring gear 159 may be rotatable more smoothly and may prevent noise. Owing to such a structure, the motion of the upper rim 120a and the lower rim 120b may be rotated more smoothly and stably.

Referring back to FIGS. 3 and 4, in an embodiment, interlocking gears 123a and 123b engaged with each other and rotating may be provided at one end 122a of the upper rim 120a and one end 122b of the lower rim 120b, respectively. Accordingly, the motion of any one of the upper rim 120a and the lower rim 120b may be linked to the motion of the other rim. Owing to such a structure, the rotational speed and the amount of rotation of the upper rim 120a and the lower rim 120b may be maintained equally at a constant level and rotated.

The foldable steering wheel according to the above-described embodiment may have the rim that folds or unfolds. In addition, the steering wheel may automatically fold or unfold depending on whether a vehicle is in an autonomous driving state, and fold the rim through the linear motion and rotational motion of the rim, thereby securing the driver's seat space. In addition, the foldable steering wheel may increase torque for rotating the rim and simultaneously reduce noise while saving space by using the cycloid gear reducer, and prevent a driver from forcibly rotating the rim while rotating the rim by the actuator.

In the foldable steering wheel according to an embodiment of the disclosure, a rim may fold or unfold.

In addition, the foldable steering wheel may automatically fold or unfold depending on whether a vehicle is in an autonomous driving state.

In addition, the foldable steering wheel may secure the driver's seat space by folding the rim through the linear motion and rotational motion of the rim.

In addition, the foldable steering wheel may increase torque for rotating the rim and simultaneously reduce noise while saving space by using a cycloid gear reducer.

In addition, the foldable steering wheel may prevent a driver from forcibly rotating the rim while rotating the rim by an actuator.

The effects of the disclosure are not limited to the above-mentioned effects, and other effects not mentioned will be clearly understood by one of ordinary skill in the art from the description provided above.

Although the disclosure has been described with reference to the embodiment shown in the drawings, this is merely exemplary and will be understood by one of ordinary skill in the art that various modifications and equivalent other embodiments are possible. Therefore, the true technical protection scope of the disclosure will be defined by the technical sprit of the appended claims.

What is claimed is:

1. A foldable steering wheel comprising:
a hub;
a rim moving relative to the hub; and
an actuator unit moving the rim with respect to the hub,
wherein the actuator unit includes:
a motor;
a cycloid gear reducer configured to receive power from an output shaft of the motor, and
wherein an output shaft of the cycloid gear reducer is connected to one end of the rim to move the rim between a first position in which the rim is unfolded for a driver to grip and a second position in which the rim is folded.

2. The foldable steering wheel of claim 1, wherein the actuator unit further includes a bevel gear reducer provided between the output shaft of the motor and the cycloid gear reducer and using a bevel gear.

3. The foldable steering wheel of claim 1, wherein the cycloid gear reducer comprises:
an input shaft to which rotational power of the motor is input;
a sun gear unit having a hollow portion into which the input shaft is inserted, the sun gear unit being configured to eccentrically rotate in association with rotation of the input shaft;
an input ring gear meshing with a first sun gear of the sun gear unit in a cycloid motion manner; and
an output ring gear meshing with a second sun gear of the sun gear unit in the cycloid motion manner and rotating.

4. The foldable steering wheel of claim 3, wherein the input shaft includes an eccentric cam portion inserted into the hollow of the sun gear unit, and
the sun gear unit eccentrically rotates according to the rotation of the input shaft.

5. The foldable steering wheel of claim 4, wherein the second sun gear of the sun gear unit includes a plurality of sun gears having a phase difference with different tooth shapes and disposed side by side.

6. The foldable steering wheel of claim 5, wherein the second sun gear includes two sun gears having a phase difference of 180 degrees and disposed side by side, and
the eccentric cam portion of the input shaft includes two cam portions having a phase difference of 180 degrees.

7. The foldable steering wheel of claim 2, wherein the bevel gear reducer includes:
a first bevel gear portion intersecting the output shaft of the motor; and
a second bevel gear portion intersecting a rotation shaft of the first bevel gear portion, and
the input shaft of the cycloid gear reducer is coaxially connected to a rotation shaft of the second bevel gear portion.

8. A foldable steering wheel comprising:
a hub;
an upper rim and a lower rim moving relative to the hub; and
an actuator unit moving the upper rim and the lower rim with respect to the hub,
wherein the actuator unit includes:
a motor; and
a pair of cycloid gear reducers configured to receive power from an output shaft of the motor,
wherein respective output shafts of the pair of cycloid gear reducers are respectively connected to one end of the upper rim and one end of the lower rim to move the upper rim and the lower rim between a first position in which the upper rim and the lower rim are unfolded for a driver to grip and a second position in which the upper rim and the lower rim are folded.

9. The foldable steering wheel of claim 8, wherein interlocking gears engaged with each other and rotating are provided at one end of the upper rim and one end of the lower rim, respectively, and a motion of any one of the upper rim and the lower rim is linked to a motion of another rim.
